(19) United States
(12) Patent Application Publication
(10) Pub. No.: US 2010/0150300 A1
(43) Pub. Date: Jun. 17, 2010

(54) NUCLEAR FUEL IN THE FORM OF A PELLET, WITH IMPROVED STRUCTURE

(75) Inventors: Jean-Christophe Couty, Saumur (FR); Pascal Esposito, Chaville (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: ELECTRICITE DE FRANCE, Paris (FR)

(21) Appl. No.: 12/599,726

(22) PCT Filed: May 13, 2008
(86) PCT No.: PCT/FR08/50824

§ 371 Date: Feb. 23, 2010

(30) Foreign Application Priority Data
May 14, 2007 (FR) 0703453

(51) Int. Cl. G21C 3/16; G21C 21/02

(52) U.S. Cl. 376/409; 264/5

(57) ABSTRACT

A pellet including a nuclear fuel material for applications in reactors. The pellet has an elongated shape along an axis (z) and includes on an outer radial surface at least one privileged breaking area (R2) for promoting a breaking in a plane substantially perpendicular to the axis (z). During a temperature rise of the pellet, the pellet is broken along the privileged breaking areas into several fragments having a smaller slenderness ratio than that of the entire pellet, which contributes to lessen the stresses on the sheath housing such pellets.

The present invention relates to a nuclear fuel intended for applications in nuclear reactors.

More particularly, it relates to a fuel in pellet form intended for bundled fuel rods in reactors, in particular for electricity generation.

Example applications include:
pressurized water reactors (PWR),
boiling reactors, or also
fast neutron reactors.

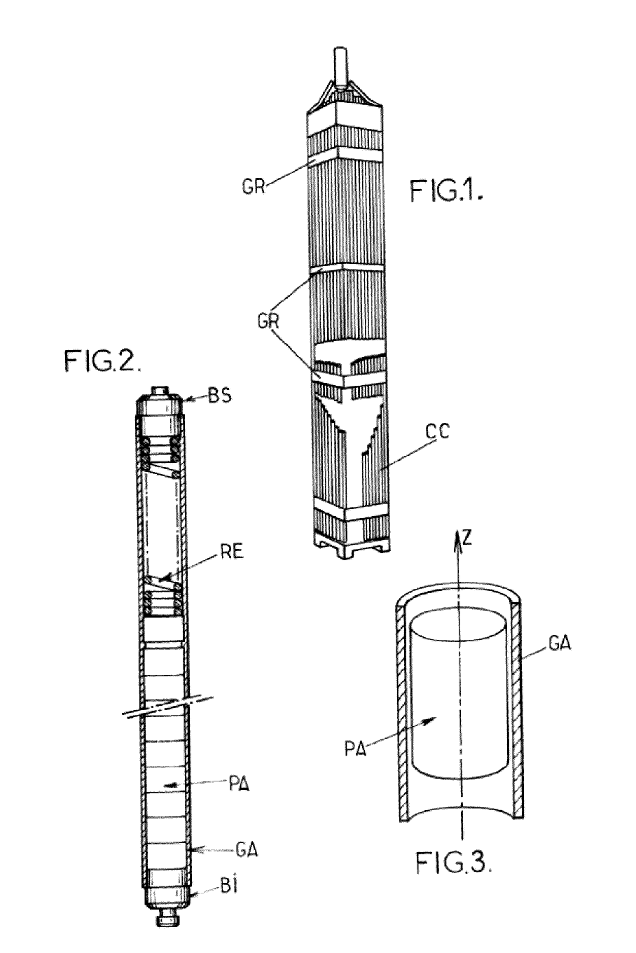

With reference to FIG. 1, in a reactor for one of the applications of the above type, tubes CC (called “fuel rods”) are assembled using in particular spacer grids GR. In each fuel rod (FIG. 2), a plurality of fuel pellets PA are inserted into a cladding GA. The fuel pellets are for example made of uranium dioxide UO₂, optionally doped. The cladding GA is for example produced from a zirconium alloy. The pellets PA are held in the cladding by upper BS and lower BI end caps and remain held together by the pressure of at least one spring RE.

With reference to FIG. 3 given here by way of example, each pellet PA appears substantially similar to a cigarette filter. It is a cylinder the dimensions of which are for example approximately 13 millimetres high (along the axis z) and approximately 8 millimetres in diameter. Depending on the application, the pellet PA can be hollow or solid. It can also be only partially hollow and have for example a recess. With respect to the cladding GA, this is approximately 9 millimetres in diameter and approximately 4 metres high.

Thus, in a pressurized water reactor for example, the nuclear fuel is in the form of pellets PA stacked in claddings GA the function of which is to hold the pellets and contain the fission products in order to prevent their dispersion in the water of the primary circuit. The fuel rods thus formed are arranged in the form of a fuel assembly (for example in a lattice of 17×17 fuel rods) the mechanical resistance of which is provided by the grids GR, as shown in FIG. 1.

The cladding GA of each fuel rod constitutes the first protective barrier against the discharge of nuclear fission product. This cladding must remain intact in all situations of normal operation, as well as in all incidental transitory events in the reactors of the above type.

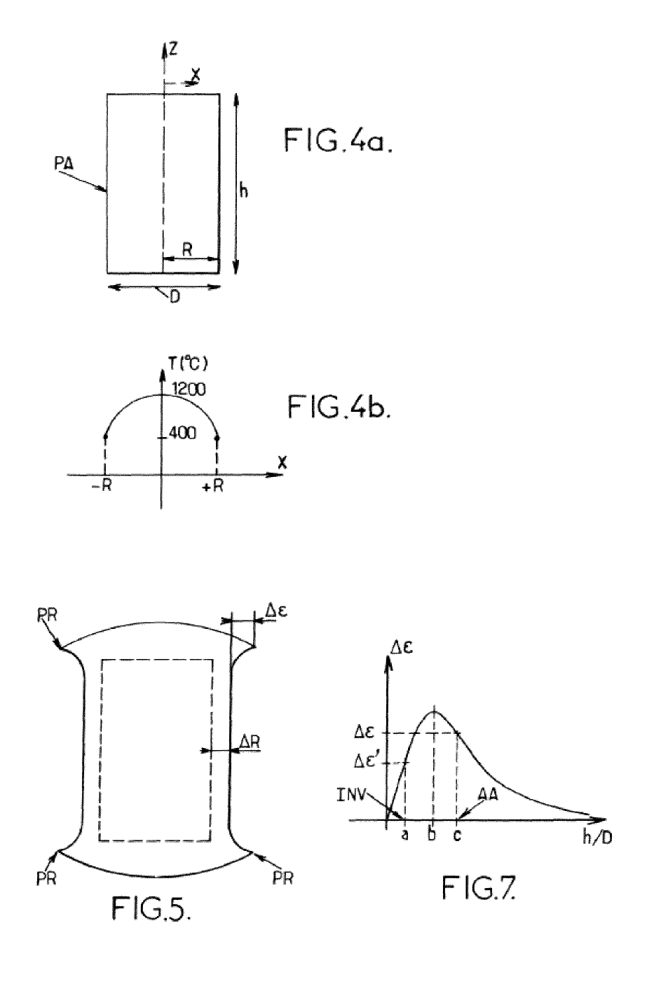

As soon as the reactor is powered up, the fission reaction produces a release of heat in the pellet. FIG. 4b shows the heat distribution in the pellet PA compared with its dimensions in FIG. 4a (which conforms to the usual proportions of a pellet). In normal operation and at full power, the heat distribution is substantially parabolic over the diameter of the pellet, with a temperature of approximately 1200° C. at the centre and a temperature of approximately 400° C. at the edges (−R and +R on the axis x of FIG. 4b, this axis x being orthogonal to the axis z). The heat increase at the centre of the pellet PA then leads to a radial deformation by thermal expansion that is greater at the upper and lower ends of the pellet. Thus, referring now to FIG. 5, under the effect of the thermal expansion, the pellet adopts a “diabolo” shape with particularly marked radial projections PR at the ends of the pellet.

In FIG. 5, dotted lines show the initial shape of the pellet (before the temperature increase) and solid lines, the shape of the expanded pellet. In particular, at the ends of the pellet, an increase in diameter Δε is noted, in addition to the normal radial expansion ΔR of the centre of the pellet. This over-expansion Δε, which is more marked at the lower and upper ends of the generally cylindrical pellet, is linked to edge effects on a cylinder of finished size.

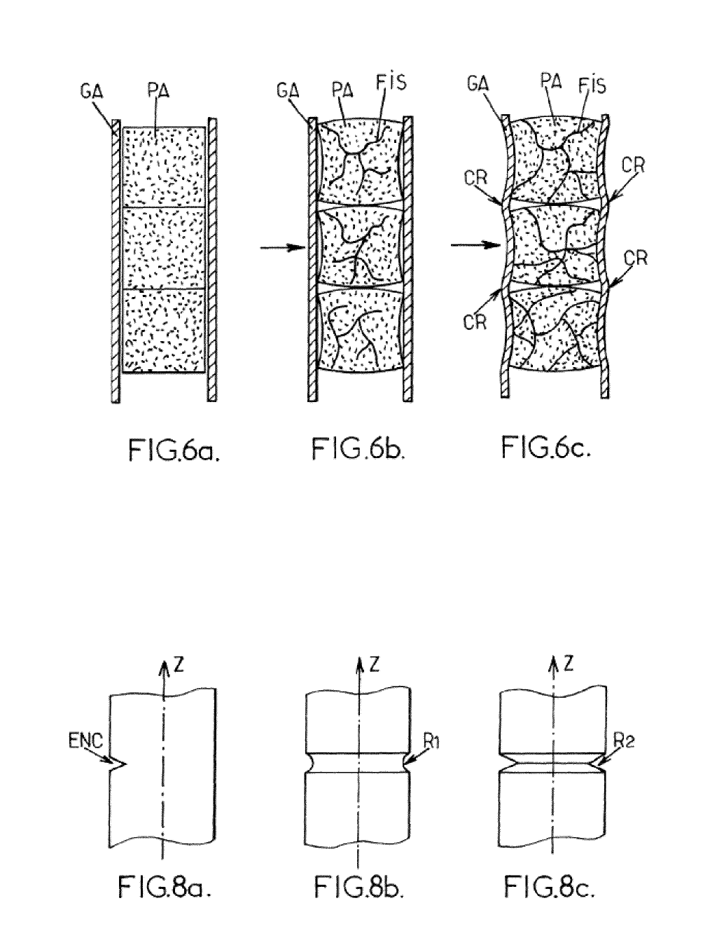

With reference to FIGS. 6a, 6b and 6c, showing a progressive temperature increase of the pellets PA in their cladding GA, the marked increase in the diameter Δε at the ends of the pellets then generates stresses CR in the cladding GA. This effect places the cladding under mechanical stress and contributes to its weakening, the latter becoming more severe as the over-expansion Δε increases. Furthermore, ripples on the radial surface of the cladding have been noted after use, with a gap between ripples corresponding to the height of a pellet, exactly as shown in FIG. 6c.

It must also be noted in FIGS. 6b and 6c, that from the start of the temperature increase, fissures FIS are randomly formed in the pellets. In fact, the thermal gradient imposed on the pellet generates severe tensile stress in the ceramic pellet, as this is a fragile material.

Referring now to FIG. 7, it was noted that the additional increase in diameter Δε was linked to the slenderness ratio of the pellet, typically measured by the ratio h/D of its height h to its diameter D. FIG. 7 shows the variation of the additional increase in diameter Δε as a function of the slenderness ratio h/D. This variation has a single maximum for a slenderness ratio h/D of a value b (which is for example of the order of 0.9 to 1.3). For pellets of the state of the art, approximately 13 millimetres high by approximately 8 millimetres in diameter, the slenderness ratio h/D is close to c=1.6 (arrow AA for “prior art” in FIG. 7) and the additional increase in diameter at the ends of the pellet, Δε, is still significant and close to the maximum.

A solution for limiting the over-expansion Δε would be to provide slenderness ratio values h/D that are below the value b, for example close to a value a which could typically be less than, or of the order of, 0.5 (arrow INV for “invention” in FIG. 7). This embodiment would then consist of providing for example pellets of a height of 3 millimetres approximately, in order to retain a diameter of 8 millimetres. Such pellets would typically have the shape of a flat watch battery. The problem then arises of the insertion and stacking of the pellets in a 4-metre cladding, without at least some of the pellets pivoting and adopting a slanted position in the cladding.

The present invention aims to improve the situation.

To this end the invention proposes a pellet comprising a nuclear fuel material, having a generally elongated shape along one axis (typically the axis z in the example shown in FIG. 3).

The pellet according to the invention then comprises at least one privileged breaking area on an external radial surface, in order to promote breaking substantially in an intersecting plane of said axis.

This privileged breaking area is typically a recess cut on the outer surface of the pellet. This can be for example a stamp, a notch, a groove or other, the principle being that as soon as the temperature starts to rise, the pellet within the meaning of the invention is able to crack in an intersecting plane (for example perpendicular) to the axis z in FIG. 3.

In an advantageous embodiment, the pellet comprises more than one privileged breaking area so as to obtain a slenderness ratio of each piece, after breaking, less than, or of the order of 0.5, which makes it possible to reduce substantially the parameter Δε in FIG. 7, in comparison with the prior art (arrow AA). In particular, the number of privileged breaking areas that the pellet comprises can be chosen to promote breaking into several fragments, each fragment then having a height-to-width ratio less than, or of the order of 0.5.

Thus, if the pellet initially has a height-to-width ratio greater than, or of the order of, 1.5, at least two privileged breaking areas can advantageously be provided, that can for example be arranged substantially at one third and two thirds of the height of the pellet, respectively.

In an embodiment described in detail below the pellet comprises three privileged breaking areas for a slenderness ratio close to 1.6.

Moreover, other features and advantages of the invention will become apparent on examining the detailed description below, and the attached drawings in which:

FIG. 1 shows a nuclear fuel assembly with fuel rods,

FIG. 2 is a cross section view of a fuel rod,

FIG. 3 shows a nuclear fuel pellet in a cladding forming a fuel rod,

FIG. 4a shows the proportions of a conventional pellet,

FIG. 4b shows a temperature distribution in the pellet, during the nuclear fission reaction, in normal operation at full power,

FIG. 5 shows the expansion undergone by a pellet during the fission reaction, in normal operation at full power,

FIGS. 6a to 6c show the deformation of the pellets under the effect of the temperature increase during the nuclear fission reaction, leading to the stresses CR imposed on the cladding,

FIG. 7 shows a variation of an additional increase in diameter Δε at the lower and upper ends of the pellet, as a function of its slenderness ratio h/D,

FIGS. 8a to 8c show different embodiments of a privileged breaking area produced in a pellet within the meaning of the invention,

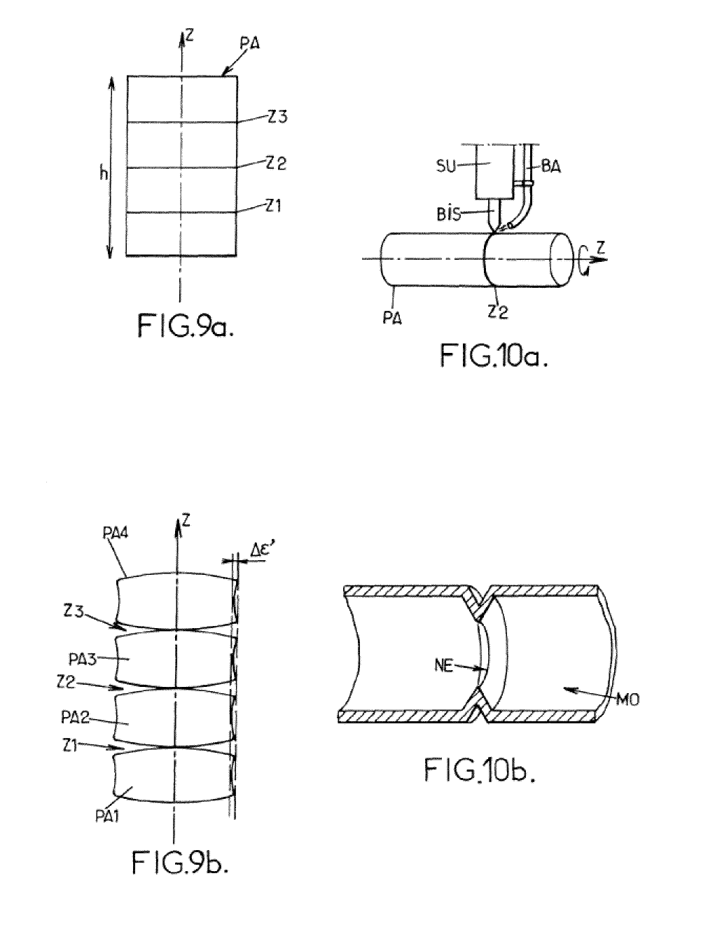

FIG. 9a shows a pellet comprising three privileged breaking areas, in an advantageous embodiment,

FIG. 9b shows the pellet in FIG. 9a during a nuclear fission reaction when the first temperature increase of a novel pellet within the meaning of the invention takes place,

FIG. 10a shows diagrammatically an installation for implementing a method of forming privileged breaking areas in the pellets within the meaning of the invention, and

FIG. 10b is a cross section view of a sintering mould for producing pellets within the meaning of the invention and comprising privileged breaking areas directly on output from the mould.

FIG. 9a shows a pellet within the meaning of the invention comprising a height-to-width ratio close to 1.6. Three privileged breaking areas are provided, arranged at substantially a quarter Z1, a half Z2 and three quarters Z3 of the height h of the pellet PA, respectively. Thus, during a first power build-up, the pellet cracks into at least four pieces PA1, PA2, PA3 and PA4, as shown in FIG. 9b, each piece having a slenderness ratio close to 0.4. With reference to FIG. 7, with this slenderness ratio of 0.4, the additional increase in diameter Δε′ of each piece PA1, PA2, PA3 or PA4 is substantially less than that Δε of a whole pellet having a slenderness ratio of 1.6. As a result, referring once again to FIG. 9b, with the low Δε′ value achieved for the group of pieces PA1 to PA4 forming the pellet, the stresses imposed on the cladding GA are significantly reduced.

With reference to FIG. 7, a solution that appeared equally advantageous to a person skilled in the art for limiting over-expansion Δε was to choose slenderness ratio values h/D greater than the maximum value b (which therefore, for a constant diameter, means increasing the height of the pellets). In fact, the over-expansion Δε is reduced again for slenderness ratios greater than the value b. However, the cracks created in the pellet can typically produce fragments, the slenderness ratio of which is close to the value b, which does not resolve the problem posed by the over-expansion Δε.

Moreover, it is recalled in order to state the absolute dimensions of a pellet before breaking, that its height is greater than, or of the order of, one centimetre, for example 13 millimetres high for 8 millimetres diameter, in order to conform to the conventional dimensions of the pellets of the state of the art. Thus, the method envisaging stacking the pellets in the cladding GA remains unchanged and more generally, without modifying overall the shape and dimensions of the pellets, their over-expansion Δε, and thus the stresses undergone by the cladding GA, can be reduced advantageously.

With reference to FIG. 8a, a privileged breaking area formed in a pellet within the meaning of the invention can have the form of a notch ENC produced as an indentation on the radial surface of the pellet and extending at least over an arc of circle of this surface.

In the embodiment shown in FIGS. 8b and 8c, the notch can extend over a full circle inscribed in a plane substantially perpendicular to the axis z of the height of the pellet, in order to form a groove R1 or R2 having an approximately constant depth.

In the embodiment in FIG. 8b, the groove is U-shaped, while in the embodiment in FIG. 8c, the groove is V-shaped. The embodiment in FIG. 8c can be preferred as it causes very rapid breaking of the pellet, as soon as it increases in temperature. In this case, if the pellet is engraved by machining to form the grooves R2, a pointed machine tool will be chosen. More generally, the shape and/or depth of the groove R1 or R2 can be chosen to cause breaking of the pellet more or less rapidly. Nonetheless, the deeper the grooves machined, the greater the quantity of nuclear material removed from the pellets, posing a problem of recycling the nuclear materials.

FIG. 10a shows an example of a machining method to which the present invention also relates in which at least one privileged breaking area Z2 is engraved in the pellet PA, while providing in particular for recovery of the machining waste. In this embodiment, the pellet PA is rotated, while a pointed machine tool BIS is applied against the radial outer surface of the pellet. Advantageously, the pointed machine tool BIS is fixed on a support SU and a suction nozzle BA is fixed onto the same support BU in order to recover, by direct suction, the machining waste generated. Thus recovered, said nuclear material can be recycled in order to produce other pellets for example.

A variant of this method of forming privileged breaking areas in the pellet can consist of producing the pellet PA directly, by moulding, from a ceramic comprising a nuclear fuel material, and by providing in particular a mould MO comprising at least one rib NE forming a projection on an inner wall of the mould, as shown in FIG. 10b. Each rib NE of the cylindrical mould MO applies an indentation in the pellet during production by sintering, thus forming a circular groove of the type shown for example in FIG. 8c.

Of course, the present invention is not limited to the embodiment described above by way of example; it extends to other variants.

Thus, solid pellets are shown in the drawings by way of example. However, the invention can be applied to any type of pellet, in particular to hollow pellets. In order to produce the privileged breaking areas on such hollow pellets, it is planned in practice to still form these areas (by machining or by moulding as described previously) on their radial outer surface.

Moreover, pellets having a generally cylindrical shape have been described above. As In a variant, different shapes can be provided, for example oblong, parallelepipedic or others.

As described above, the grooves are preferably formed on an entire circle of the outer surface of a pellet and are each inscribed in a plane perpendicular to the axis z of the height of the pellet. In principle, when the pellet breaks, the break is also inscribed in the same plane perpendicular to the axis z and, if the pellet comprises N grooves, it breaks into N+1 pieces. However, it is possible that it can accidentally break into more than N+1 pieces and/or that the break is not in a plane perfectly perpendicular to the axis z but simply in a plane intersecting said axis.

1. A pellet comprising a nuclear fuel material, having a generally elongated shape along an axis, said pellet comprising, on a radial outer surface, at least one privileged breaking area for promoting a breaking substantially in a plane intersecting said axis.

2. The pellet according to claim 1, having a substantially cylindrical shape and a substantially circular base, wherein the privileged breaking area comprises a notch extending at least over an arc of circle.

3. The pellet according to claim 2, wherein the notch forms a groove having a substantially constant depth.

4. The pellet according to claim 3, wherein the groove extends over a full circle inscribed in a plane substantially perpendicular to said axis.

5. The pellet according to claim 1, comprising a chosen number of privileged breaking areas for promoting a breaking into a plurality of fragments, each fragment having a height-to-width ratio less than, or of the order of, 0.5.

6. The pellet according to claim 5, comprising a height to width ratio greater than, or of the order of, 1.5, and comprising at least two privileged breaking areas.

7. The pellet according to claim 6, comprising a height to width ratio approximately 1.6, and comprising three privileged breaking areas, arranged approximately at a quarter, half and three quarters of the height of the pellet, respectively.

8. The pellet according to claim 6, wherein the height of the pellet is greater than, or of the order of, one centimeter.

9. A method for the production, by sintering, of a pellet from a ceramic comprising a nuclear fuel material, said pellet having a generally elongated shape along an axis, and comprising on a radial outer surface at least one privileged breaking area for promoting a breaking substantially in a plane intersecting said axis, wherein a mould is provided comprising at least one rib forming a projection on an inner wall of the mould.

10. A method for the production, by machining, of a pellet having a generally elongated shape along an axis, and comprising on a radial outer surface at least one privileged breaking area for promoting a breaking substantially in a plane intersecting said axis, wherein at least one privileged breaking area is engraved in the pellet, and wherein provision is made for recovery of the machining waste for recycling.
